(19) United States
(12) Patent Application Publication
(10) Pub. No.: US 2023/0374681 A1
(43) Pub. Date: Nov. 23, 2023

(54) EIS MONITORING SYSTEMS FOR ELECTROLYZERS

(71) Applicant: Analog Devices, Inc., Wilmington, MA (US)

(72) Inventors: Atulya Yellepeddi, Medford, MA (US); Brian Harrington, Upton, MA (US); Sasha Dass, Somerville, MA (US); Antonio Montalvo, Raleigh, NC (US)

(21) Appl. No.: 18/042,543

(22) PCT Filed: Feb. 4, 2022
(86) PCT No.: PCT/US2022/015338

§ 371 Date: Feb. 22, 2023

Related U.S. Application Data
(60) Provisional application No. 63/150,308, filed on Feb. 17, 2021.

(51) Int. Cl. C25B 15/025; C25B 9/70

(52) U.S. Cl. CPC C25B 15/025; C25B 9/70

(57) ABSTRACT

Systems and methods are provided for operating an electrolyzer. The systems and methods perform operations comprising obtaining a plurality of impedance measurements of the plurality of electrolytic cells at a plurality of frequencies; tracking changes to the plurality of impedance measurements of the plurality of electrolytic cells over a time period; and generating, based on the changes to the plurality of impedance measurements, a model representing operating conditions of the electrolytic cells on an individual electrolytic cell basis.

### CROSS REFERENCE TO RELATED APPLICATION

This application claim priority to U.S. Provisional Application No. 63/150,308, filed Feb. 17, 2021 and Entitled “EIS MONITORING SYSTEMS FOR ELECTROLYZERS.” The contents of this prior application are considered part of this application and are hereby incorporated by reference herein in their entirety.

### FIELD OF THE DISCLOSURE

This document pertains generally, but not by way of limitation, to Electrochemical Impedance Spectroscopy (EIS), and specifically to EIS monitoring of electrolysis cells.

### BACKGROUND

Fuel cells are used to convert chemical energy (usually from hydrogen) to electrical energy. Since each fuel cell usually produces between 1 and 2 volts, oftentimes such fuel cells are stacked in series in order to produce a high power at a relatively low current. Hydrogen can also be generated with similar devices. Instead of hydrogen and oxygen as inputs and electrons as the desired output, the inputs are electricity and water, and hydrogen is the desired output.

### OVERVIEW

This disclosure describes, among other things, techniques to operate electrolysis cells.

The techniques include a system that includes an electrolyzer comprising a plurality of electrolytic cells, each of the electrolytic cells comprising an electrolyte, two electrodes and a pair of bipolar plates. The system includes monitoring circuitry coupled to the plurality of electrolytic cells, the control circuitry configured to perform operations comprising: obtaining a plurality of impedance measurements of the plurality of electrolytic cells at a plurality of frequencies tracking changes to the plurality of impedance measurements of the plurality of electrolytic cells over a time period; and generating, based on the changes to the plurality of impedance measurements, a model representing operating conditions of the electrolytic cells on an individual electrolytic cell basis.

In some implementations, the model is configured to estimate at least one of state-of-health or performance of a given electrolytic cell, predict whether the given electrolytic cell is operating and degrading normally or abnormally, or identify an abnormality of the electrolytic cell.

In some implementations, the model comprises a machine learning technique that is trained based on training data to predict health of an electrolytic cell, the training data comprising a plurality of training samples of Electrochemical Impedance Spectroscopy (EIS) data and associated performance or failure information.

In some implementations, the monitoring circuitry comprises an Electrochemical Impedance Spectroscopy (EIS) measurement system, the EIS generating an impedance as a function of frequency of each of the plurality of electrolytic cells.

In some implementations, the EIS generates the impedance over a range of frequencies from 0.1 mHz to 40 kHz or higher, a subset of frequencies within the range of frequencies, or one or more specific frequencies within the range of frequencies.

In some implementations, the operations further comprise: converting the measurements into a plurality of components of an equivalent (electrochemical) circuit model representing each electrolytic cell by solving a set of equations that relate a total impedance of the cell to the impedance of each of the components at a number of frequencies, tracking values of the components over time to determine whether any of the components are changing over time, and identifying one or more of the operating conditions that correspond to the components that are changing over time.

In some implementations, the plurality of components comprise a first component representing resistance of electron-conducting metallic cell components at a cathode and an anode, respectively; a second component representing ionic resistance of a solid polymer electrolyte (SPE); a third component representing cathodic polarization resistance; a fourth component representing anodic polarization resistance; a fifth component representing a cathodic constant phase element; a sixth component representing an anodic constant phase element for a pseudo-capacitive anode/electrolyte interface; a seventh component representing cathodic diffusion impedance; and an eighth component representing anodic diffusion impedance.

In some implementations, the operations further comprise: applying a stimulus input in parallel with the power supply of the electrolyzer; measuring cell voltages of each of the plurality of electrolytic cells as a result of applying the stimulus input; synchronously demodulating the measured cell voltages of the plurality of electrolytic cells based on the applied stimulus input; and computing the impedance of the plurality of electrolytic cells based on the demodulated measured cell voltage of the plurality of electrolytic cells.

In some implementations, the stimulus input comprises a sinusoid signal cycled through the plurality of frequencies or the sum of several sinusoid signals.

In some implementations, the stimulus input comprises a wideband signal.

In some implementations, the operations further comprise filtering the demodulated measured cell voltage of the plurality of electrolytic cells.

In some implementations, synchronously demodulating comprises performing IQ demodulation by: shifting the stimulus input by 90 degrees; multiplying the measured cell voltage of each cell by the stimulus input to generate an in-phase (I) component of the demodulated cell voltage; and simultaneously measuring the measured cell voltage of each cell by the shifted stimulus input to generate a quadrature (Q) component of the demodulated cell voltage.

In some implementations, the operations further comprise: measuring a plurality of voltages of the plurality of electrolytic cells over the time period; measuring a total voltage of a stack of the plurality of electrolytic cells over the time period; and estimating the plurality of impedance measurements based on the measured plurality of voltages of the plurality of electrolytic cells and the measured total voltage of the stack, such that in the time period multiple measurements of each cell voltage and the total voltage are performed and the impedance is estimated based on an assumption that the impedance does not vary during the time-period.

In some implementations, the plurality of impedance measurements are estimated to maximize a likelihood function of the measured plurality of voltages and the total voltage of the stack over the time period, the likelihood function comprising a probability of observed voltages as a function of the impedance.

In some implementations, the operations further comprise: generating, by a feature extractor, a feature representation that contains information for classification based on the impedance as a function of frequency; and determining, by a classifier, whether the plurality of features represent abnormal operation of the electrolyzer.

In some implementations, the classifier is trained by: obtaining a plurality of training data comprising a plurality of training impedance profiles; computing a cost function based on a deviation between the plurality of training impedance profiles and predetermined impedance profiles representing normal operating conditions; and updating parameters of the classifier based on the cost function.

In some implementations, the feature extractor is configured to compare the feature representation to predetermined feature representations representing normal operating conditions to determine abnormal operation of the electrolyzer.

In some implementations, the other parameters comprise at least one of flow rate, temperature, stack voltage, or stack current.

In some implementations, the operations further comprise: determining a first type of fault of the electrolyzer in response to detecting a first impedance value within a first impedance range at a first frequency; and determining a second type of fault of the electrolyzer in response to detecting a second impedance value within a second impedance range at a second frequency.

The techniques include methods, systems, and non-transitory computer-readable media for performing operations comprising: obtaining, by monitoring circuitry coupled to a plurality of electrolytic cells of an electrolyzer, a plurality of impedance measurements of the plurality of electrolytic cells at a plurality of frequencies, each of the electrolytic cells comprising an electrolyte, two electrodes and a pair of bipolar plates; tracking changes to the plurality of impedance measurements of the plurality of electrolytic cells over a time period; and generating, based on the changes to the plurality of impedance measurements, a model representing operating conditions of the electrolytic cells on an individual electrolytic cell basis.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an example of an electrolyzer system, in accordance with various embodiments.

FIG. 2 is a block diagram of an example of an electrolytic cell, in accordance with various embodiments.

FIG. 3 is a block diagram of an example of an electrolyzer system, in accordance with various embodiments.

FIG. 4 is a block diagram of an example of an equivalent circuit model of an electrolyzer system, in accordance with various embodiments.

FIG. 5 is a block diagram of an example of a control circuit for an electrolyzer system, in accordance with various embodiments.

FIG. 6 is a block diagram of an example of a noise filter for an electrolyzer system, in accordance with various embodiments.

FIG. 7 is a block diagram of an example of a control circuit for an electrolyzer system, in accordance with various embodiments.

FIG. 8 is a block diagram of an example of an electrolyzer system with bypass components, in accordance with various embodiments.

FIG. 9 is a flow diagram depicting an example process for operating an electrolyzer, in accordance with various embodiments.

FIG. 10 is a block diagram illustrating an example of a machine upon which one or more embodiments may be implemented.

### DETAILED DESCRIPTION

This disclosure describes, among other things, techniques to configure an electrolyzer or hydrolyzer to generate hydrogen and/or oxygen. The disclosure uses an EIS monitoring technique to monitor health of electrolysis cells of the electrolyzer.

Specifically, a system to monitor the performance, state-of-health and (potentially) the remaining useful life (RUL) of a hydrogen electrolyzer is disclosed. Two potential methods to extract the impedance at multiple frequencies of the individual cells of an electrolyzer are discussed (with and without an additional stimulus current supply). Once the impedance is measured, the measurements at various times are passed to an edge- or cloud-based machine learning system that tracks the changes in impedance of each cell to monitor the performance of the electrolyzer. The goal is to assess the state-of-health and provide information to the electrolyzer operator to properly control and maintain the electrolyzer system.

An electrolyzer typically includes one or more electrolytic cells. Each electrolytic cell has three component parts: an electrolyte, two electrodes (a cathode and an anode) and bipolar plates to distribute the gases even over the electrolyte. The electrolyte is usually a solution of water or other solvents in which ions are dissolved. Molten salts such as sodium chloride are also electrolytes. When driven by an external voltage applied to the electrodes, the ions in the electrolyte are attracted to an electrode with the opposite charge, where charge-transferring (also called faradaic or redox) reactions can take place. Only with an external electrical potential (i.e., voltage) of correct polarity and sufficient magnitude can an electrolytic cell decompose a normally stable, or inert, chemical compound in the solution. The electrical energy provided can produce a chemical reaction which would not occur spontaneously otherwise. Water, particularly when ions are added (salt water or acidic water), can be electrolyzed (subject to electrolysis). When driven by an external source of voltage, H+ ions flow to the cathode to combine with electrons to produce hydrogen gas in a reduction reaction. Likewise, OH— ions flow to the anode to release electrons and an H+ ion to produce oxygen gas in an oxidation reaction.

A system that generates hydrogen through electrolysis is called an electrolyzer or a hydrolyzer. A power generation system produces a high voltage (between 50V and 200V) and a high current (100 A to 4000 A) that is provided to a cell stack that includes electrolytic cells that each include an electrolyte and two electrodes. With water as the other input, the cell stack produces hydrogen and oxygen as outputs. If the source of power is a renewable such as solar, wind, or hydroelectric, then the entire cycle is completely carbon free. Electrolyzer cells are typically electrically connected in series. However, such configurations have several shortcomings. For example, one challenge of electrolyzers is durability. There is a specific voltage across a cell that produces an optimum combination of efficiency and durability. If the supply voltage is too high, corrosion in the electrodes can result in an increase in impedance and a shorter lifetime of the electrolyzers. The increase in impedance in one cell changes the voltage in other cells and can degrade efficiency and/or durability.

In addition, configuring the electrolyzers in series limits the scalability of the overall system, because adding or replacing electrolytic cells introduces additional challenges. For example, if one electrolytic cell in the electrolyzer breaks down, the power distribution through the system to other cells can be impacted and the overall system may also stop functioning. Namely, when the cells are in a series configuration, when one cell fails then the entire stack fails.

The generation and production of hydrogen via the electrolysis of water is predicted to be a key component of the green energy pipeline. Electricity from renewable sources, such as solar or wind, is used to produce hydrogen as a viable means of long-term energy storage. Hydrogen is a suitable fuel for a variety of applications, including (but by no means limited to) fuel cells for heavy vehicles as an alternative to batteries (such as long-distance trucks and forklifts); decarbonization of non-electrifiable processes, such as ammonia manufacture for fertilizers; and grid-based fuel cells to match the irregular availability of renewable energy to the fairly predictable demand.

The key component of such a process is the electrolyzer stack. Electrolyzer stacks can be categorized by the underlying technologies of their component electrochemical cells. Electrochemical cell types include Alkaline, exchange membrane and solid-oxide electrolyzer cells. Exchange membrane cells can be either anion exchange membranes or proton exchange membranes (PEM). This disclosure is described as it applies to proton exchange membrane electrolyzers, but the disclosure is similarly applicable to anion exchange membrane electrolyzers with minor variations.

During the operation of the electrolyzer, a number of faults can develop in any of the PEM cells. These might include degradation with time due to electrode or membrane depositions or thinning, irregular catalyst coatings, PTL protective coating deficiencies and membrane pinholes. These all have an effect on the impedance of the cell at different frequencies. For instance, in certain cases, under a high-current load of 3 A/cm2 over 1000 hours, the anode polarization resistance at low frequencies can increase substantially, whereas the series resistance (whose effect dominates at high frequency) can decrease slightly.

Commercial electrolyzers currently have limited online monitoring capabilities. While some process parameters like temperature, flow-rate and pressure of the water input and the oxygen and hydrogen produced are measured, these parameters do not provide sufficient insight to inform what predictive maintenance may be required. This also has implications for the lifetime and uptime of the electrolysis systems. The ability to predict failures can improve the ability for the operator to keep the H₂ generator online by replacing the module or performing preventative maintenance prior to a stack failure that would cause the system to be suddenly taken out of service.

According to the disclosed embodiments, a novel and resource-efficient approach to operating, configuring, monitoring and tracking performance of electrolyzers is provided. The disclosed approach uses an EIS technique to measure and understand the changes that occur in the cells of electrolyzers. Specifically, the impedance variations in cells can be correlated with various performance-degrading faults that can develop in the cells in offline measurements. Therefore, real-time measurements of the impedance of the cells as a function of frequency over time is used to provide insight into the state of health and future prognosis of an electrolyzer.

The disclosed system includes control circuitry that implements a monitoring method for PEM electrolyzers that involves measuring the impedance as a function of frequency using EIS measurement technology. This measurement is performed in the presence of the wideband noise present in the system (which could be due to the wideband noise of the power supply, electrical noise coupling from external sources, process noise internal to the stack, etc.). The evolution of the cell impedances (or equivalent circuit parameters) over time can then be tracked either by a data-driven (learned) machine learning system, or a model-based system derived using the known electrochemistry of the cell or a combination; to predict whether the cell is operating and degrading normally or abnormally; and optionally, what the abnormality is.

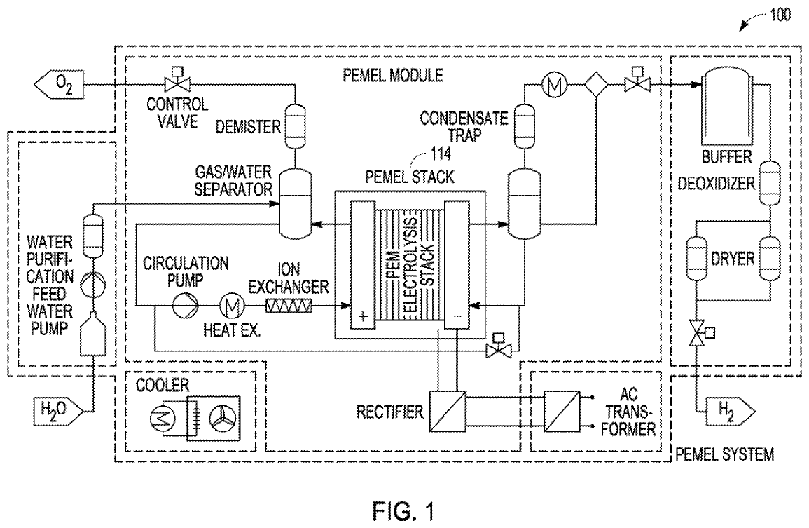

FIG. 1 is a block diagram of an example of an electrolyzer system 100, in accordance with various embodiments. The electrolyzer system 100 includes a PEMEL stack 114. The PEMEL stack 114 includes one or more cells connected electrically in parallel or in series. Each cell in the PEMEL stack 114 is driven by a common voltage source.

Each electrolytic cell includes an electrolyte coupled to receive a solution (e.g., water) and two electrodes. Each electrolytic cell outputs oxygen and hydrogen. The rate of output depends on the power received by the electrodes of the cell. In some cases, a higher power can generate oxygen and hydrogen at a faster rate, but this reduces durability of the system. On the other hand, a lower power can generate oxygen and hydrogen at a slower rate but increase durability of the system.

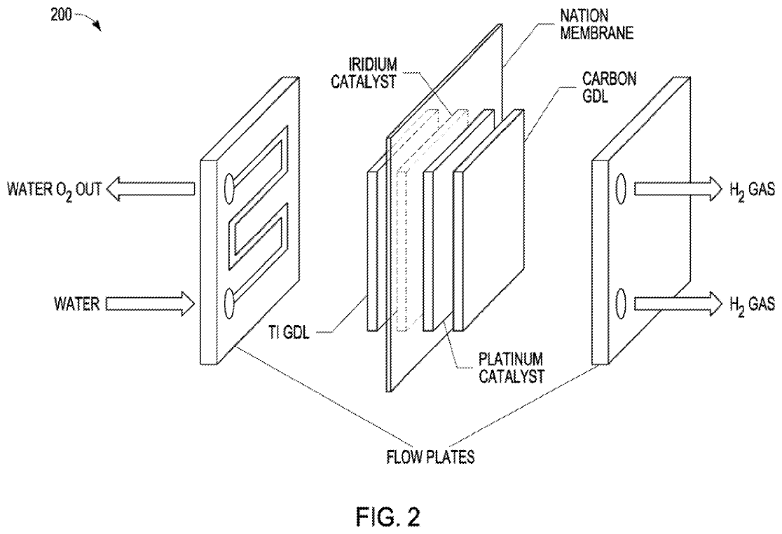

FIG. 2 is a block diagram of an example of an electrolytic cell 200, in accordance with various embodiments. Specifically, FIG. 2 shows the basic representative structure of a single cell of a PEMEL stack 114 as shown in FIG. 1. A PEMEL stack 114 consists of multiple cells laid in series, as shown in FIG. 1 though the cells can alternately be arranged in parallel. FIG. 2 shows the basic electrochemistry and production of H₂ in the cell 200. The full electrolyzer includes the PEMEL stack 114 along with control and power circuitry, as shown in FIG. 1.

In some embodiments, the electrolyzer system 100 is a 1 MW electrolyzer and can have up to 130 cells in the PEMEL stack 114, with a voltage drop of 2.2V/cell, for an overall voltage of about 300V across the PEMEL stack 114. The electrolyzer system 100 can have up to 3 A/cm2, and about 1250 cm2 for a total current through the electrolyzer system 100 of 3750 A. The per-cell impedance can be on the order of 170 uOhm/cell.

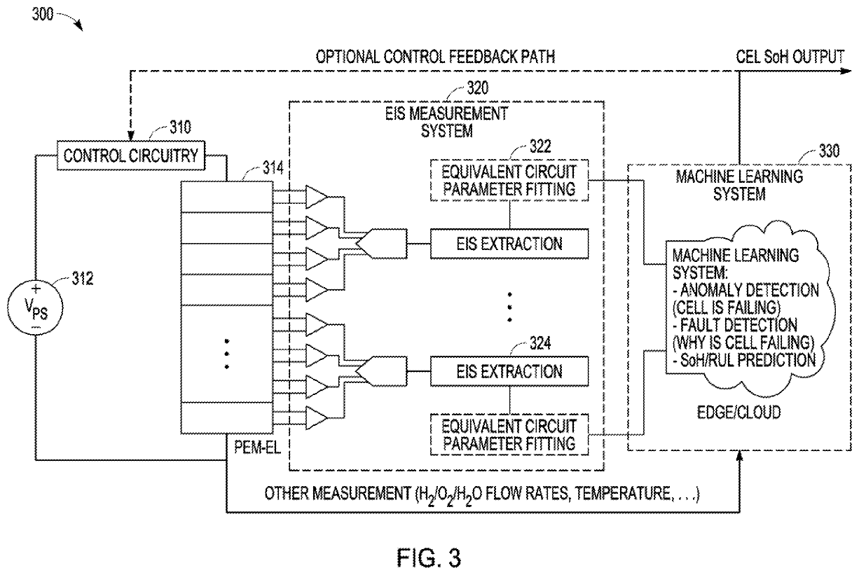

FIG. 3 is a block diagram of an example of an electrolyzer system 300, in accordance with various embodiments. The electrolyzer system 300 includes control circuitry 310, a voltage source 312, individual voltage delivery sources 314, an EIS measurement system 320, and a machine learning system 330. In some embodiments, the EIS measurement system 320 measures impedance of each cell of the stack 114 on an individual cell basis. In such cases, the EIS measurement system 320 connects to each individual cell of the stack 114 through respective measurement electrodes. In some embodiments, the EIS measurement system 320 performs measurements on a multi-cell or full stack level.

The EIS measurement system 320 includes an impedance measurement system or EIS extraction components 324. The EIS extraction components 324 perform Electro-Impedance Spectroscopy and output the impedance as a function of frequency for each cell of the stack 114. The frequency range of the measurement could range from 0.1 mHz to 10 kHz. In some cases, the impedance information is gathered from every cell or group of cells periodically over a time period (e.g., every few minutes to an hour).

In some cases, each of the EIS extraction components 324 can be shared by multiple electrolyzer cells by time-multiplexing the measurements to lower cost. For example, at a first time point within the time period, the EIS extraction component 324 can measure impedance of a first cell of a first group of cells within the stack 114. Then, at a second time point within the time period, the EIS extraction components 324 can measure the impedance of a second cell of the first group of cells within the stack 114. Another instance of the EIS extraction components 324 can, in parallel with the given EIS extraction components 324, measure the impedance of respective individual cells within a second group of cells within the stack 114.

In some cases, one EIS extraction component 324 is provided for each cell so that multiple impedance measurements can be performed in parallel across all of the cells in the stack 114.

The measurements generated by the EIS extraction components 324 can be provided to an equivalent circuit parameter fitting module 322 and/or to a machine learning system 330. The equivalent circuit parameter filling module 322 and/or a machine learning system 330 can analyze the impedance measurements over time and detect or determine whether the electrolyzer and/or individual cells within the stack 114 are operating under normal or abnormal operating conditions. As an example, when a first frequency is applied to a cell, a particular impedance measurement can be made by the EIS extraction components 324. A change in the impedance measurement can be tracked over the time period. The equivalent circuit parameter fitting module 322 and/or a machine learning system 330 can determine whether that change in impedance for the first frequency is indicative of normal or abnormal operating conditions. Specifically, if the change in impedance is outside of a given range of impedances, the equivalent circuit parameter fitting module 322 and/or a machine learning system 330 determine that a first type of fault is present in the cell. As another example, when a second frequency is applied to the same cell, a particular impedance measurement can be made by the EIS extraction components 324. A change in the impedance measurement can be tracked over the time period. The equivalent circuit parameter fitting module 322 and/or a machine learning system 330 can determine whether that change in impedance for the second frequency is indicative of normal or abnormal operating conditions. Namely, if the change in impedance is outside of a given range of impedances (which can be the same or different from the range associated with the first frequency), the equivalent circuit parameter fitting module 322 and/or a machine learning system 330 can determine that a second type of fault is present in the cell.

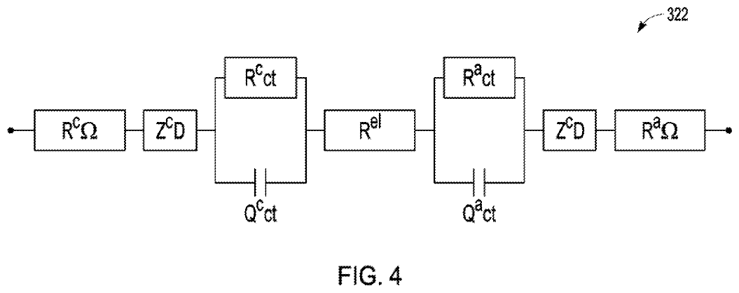

FIG. 4 is a block diagram of an example of an equivalent circuit model 322 of electrolyzer system, in accordance with various embodiments.

Specifically, the EIS measurement at multiple frequencies can be converted into the parameters of an equivalent circuit model 322 for each cell. This can be done by expressing the total impedance of a cell as a function of frequency in terms of its components and solving the resulting equations with an algorithm such as Least Squares. This may be done for reasons of reducing the data amount or the size of the feature space. It may also provide a more reliable means of interpreting failures by enabling the identification of the specific parts of the cell that are failing.

Below is a list of definitions of the various components of the equivalent circuit model 322:
RcΩ and RaΩ (Ωcm2): electronic resistance of electron-conducting metallic cell components (bipolar plates, spacers and current collectors) at the cathode and the anode, respectively
Rel (Ωcm2): ionic resistance of the SPE.
Rcct (Ωcm2): cathodic polarization (charge transfer) resistance associated with the HER.
Ract (Qcm2): anodic polarization (charge transfer) resistance associated with the OER.
Qcdl (F cm-2): cathodic constant phase element, which is used to account for the pseudo-capacitive behaviour of the charged and 3D interface between the porous catalytic layer and the electrolyte.
Qadl (F cm-2): anodic constant phase element for the pseudo-capacitive anode/electrolyte interface.
ZcD (Ωcm2): cathodic diffusion impedance due to H2 transport away from the cathode through the porous cathodic current distributor.
ZaD (Ωcm2): anodic diffusion impedance due to O2 transport away from the anode and/or to H2O transport to the anode through the porous anodic current distributor.

Based on the equivalent circuit model 322, the EIS measurement system 320 can determine the specific cause for changes in impedance for a given cell over the time period. Specifically, the equivalent circuit model 322 can identify which components of the cell and model 322 are changing as a function of frequency and which components are constant. Based on this information, the specific type of fault/cause for change in the impedance can be identified.

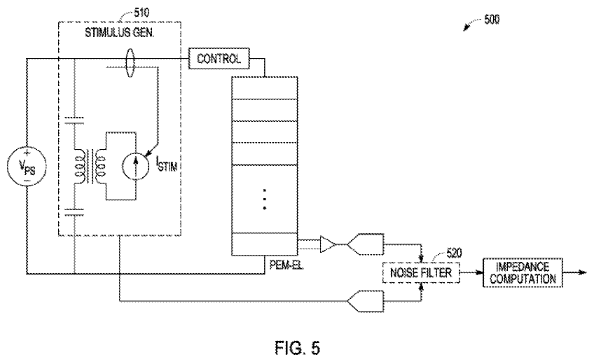

Several methods for computing the impedance by the EIS extraction components 324 are disclosed. In one embodiment, a stimulus input is provided to the power supply to measure the resulting response of the cells. This embodiment is discussed in connection with FIG. 5. In another embodiment, the impedance of each cell is determined without additional stimulus input. This embodiment is discussed in FIG. 7.

FIG. 5 is a block diagram of an example of a control circuit 500 for an electrolyzer system, in accordance with various embodiments. The control circuit 500 includes a stimulus generator circuit 510 and a noise filter 520. Control circuit 500 can be a separate component or part of the EIS measurement system 320.

The stimulus generator circuit 510 injects a sinusoidal signal which is applied as a current. In one embodiment, the stimulus input provided by stimulus generator circuit 510 can include a tunable sinusoid signal that can be cycled through the frequencies of interest. In such cases, the stimulus generator circuit 510 generates a first frequency signal and applies that signal at the first frequency to each of the cells of the stack 114. The resulting impedance is then measured across the stack of cells and is determined for each cell.

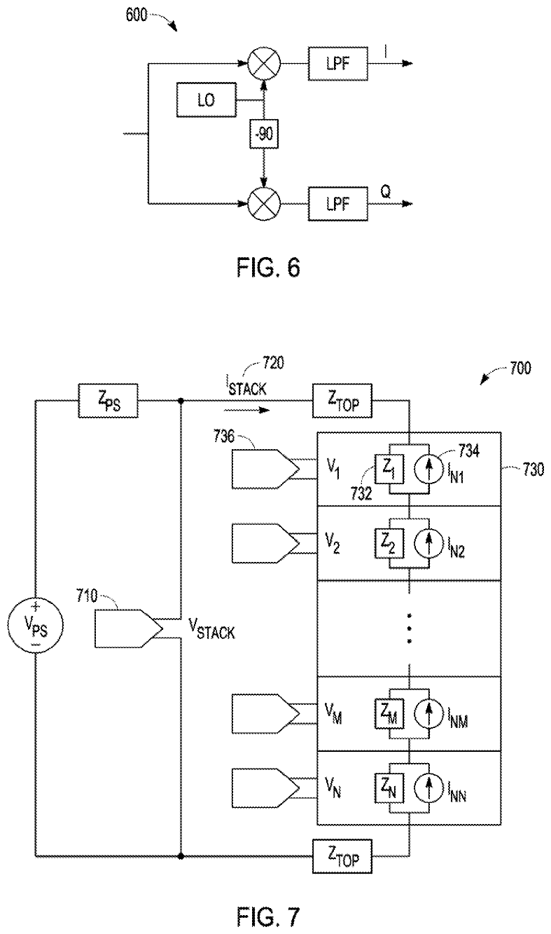

In one implementation, as shown in FIG. 6, to determine the impedance of each cell, a filter 600 is used (e.g., an IQ demodulator). Specifically, the output signal or system response to the stimulus input is synchronously demodulated with the input signal (e.g., the first frequency signal). For example, the filter 600 receives as the LO input the current first frequency signal that has been applied. The filter 600 shifts that LO signal by 90 degrees and multiplies the shifted and non-shifted signal by the output signal of each cell simultaneously. This generates in-phase (I) and quadrature (Q) components of a residual filtered signal that are then used to compute the impedance at the particular first frequency. The impedance of each of the cells while the first frequency signal is applied continues to be measured and tracked throughout the time period (e.g., over several minutes). A se of measurements representing the changes to the impedance for each cell when the first frequency signal is applied is then generated and stored.

At a second point in time within the time period or at another time period, the stimulus generator circuit 510 generates a second frequency signal and applies that signal at the second frequency to each of the cells of the stack 114. The resulting impedance is then measured across the stack of cells and is determined for each cell, such as using the IQ demodulator. The impedance of each of the cells while the second frequency signal is applied continues to be measured and tracked throughout the time period (e.g., over several minutes). A set of measurements representing the changes to the impedance for each cell when the second frequency signal is applied is then generated and stored.

These impedance computations that were generated and stored are provided and applied to the equivalent circuit parameter fitting module 322 and/or to a machine learning system 330 to determine whether the tracked impedances are associated with normal or abnormal electrolyzer operation.

In another embodiment, the stimulus input provided by stimulus generator circuit 510 can include a wideband signal that can be used to calculate the impedance at multiple frequencies at once. In such cases, the IQ demodulator shown in FIG. 6 is used to generate the residual filtered signal that is used to compute impedance at each given frequency. Specifically, the output signals from each of the cells is multiplied by a first frequency that is shifted by 90 degrees to generate a quadrature (Q) component of a first residual output signal and is simultaneously multiplied by the non-shifted first frequency signal to generate an in-phase (I) component of the first residual output signal. These components of the residual output signal are then used to compute an impedance of a given cell or the stack of cells at the first frequency. Then, the output signals from each of the cells is multiplied by a second frequency that is shifted by 90 degrees to generate a quadrature (Q) component of a second residual output signal and is simultaneously multiplied by the non-shifted second frequency signal to generate an in-phase (I) component of the second residual output signal. These components of the second residual output signal are then used to compute an impedance of a given cell or the stack of cells at the second frequency. These impedance computations that were generated and stored are provided and applied to the equivalent circuit parameter fitting module 322 and/or to a machine learning system 330 to determine whether the tracked impedances are associated with normal or abnormal electrolyzer operation.

FIG. 7 is a block diagram of an example of a control circuit 700 for an electrolyzer system, in accordance with various embodiments. Specifically, the architecture and operation shown in FIG. 7 can be used to compute and determine impedance of each cell 730 in a stack of cells without injecting a sinusoidal signal.

This method utilizes the existing system input signals, including what may be considered noise, as the stimulus signal. In this case, the input may need to be measured with sufficient resolution and sampling rate to cover the frequency range of interest.

In this case, with multiple measurements of the cell voltages 736, V₁ . . . Vₙ and the total voltage V_{stack} 710, and assuming that the cell impedances 732 change slowly relative to the cell currents 734 (and voltages 736), it is possible to infer the cell impedances 732. This can be done by modeling the probabilistic relationship between the observations (voltages) and the desired cell impedances, where the randomness comes from the local currents 734 in each cell 730. This model can be analyzed to compute impedances that maximize the likelihood of the observed voltages (e.g., with Bayesian maximum likelihood parameter estimation).

With the model of FIG. 7, the following equations can govern the measurements:

$${V}_{m} ( t ) = {Z}_{m} ( {I}_{m} ( t ) + {I}_{stack} ( t ) ) + {η}_{m} ( t ) ,$$

$${V}_{stack} ( t ) = {V}_{PS} - ( {Z}_{PS} + {\sum }_{m = 1}^{n} {Z}_{m} ) {I}_{stack} ( t ) + {η}_{stack} ( t )$$

where m is the cell index and t is the “measurement” index (e.g., observation time). In the above η(t)'s are measurement noises. In cases, where each measurement noise is represented by white Gaussian noise independent of all the other noise in the system:

ηₘ(t)˜ [symbol] (0,σ²)

η_{stack}(t)˜ [symbol] (0,σ²)

where σ is the noise power.

Additionally, the local currents 734 can be modeled at each cell 730 and the overall stack current 720 as independent random variables with the distributions:

Iₘ(t)˜ [symbol] (0,ρ²)

I_{stack}(t)˜ [symbol] (0,ρ_{stack}²)

Given these distributions, the joint distribution of the voltage observations can be modeled, which can be parameterized by the impedances. In this way, the distribution can be computed in accordance with:

p_{1:T}(V:Z)=p(V₁(1),V₂(1), . . . ,Vₙ(1),V_{stack}(1) . . . V₁(T),V₂(T), . . . ,Vₙ(T),V_{stack}(T);Z₁,Z₂, . . . ,Zₙ,Z_{PS})

In some cases, V₁(t), V₂(t), . . . , Vₙ(t), V_{stack}(t) for t=1, 2, . . . T can be observed during operation of the electrolyzer. In this case, the values of Z₁, Z₂, . . . Zₙ, Z_{PS} that maximize the probability of the observations that are made can be determined in accordance with:

\hat{Z}₁,\hat{Z}₂, . . . \hat{Z}ₙ,\hat{Z}_{PS}=arg max_{Z}_{₁}_{,Z}_{₂}_{, . . . ,Z}_{ₙ}_{,Z}_{_{PS}}p_{1:T}(V;Z)

The noise and current models can be generalized to have any distributions and can also have memory. Namely, the distribution of Iₘ(t) can be made dependent on Iₘ(t-1). Based on the voltage-current model, the distribution of the voltages over the observation period can be determined. Depending on the choice of distributions, the optimization can be solved numerically or in closed form to obtain the cell impedances over frequency and time.

In some cases, a cell level DC voltage measurement can be used to track operation of each cell of the electrolyzer, and specifically to track changes or measurements of temperature and pressure of each cell or a stack of cells. Specifically, the control circuit 700 can measure the DC voltage across each cell of the electrolyzer. The DC cell voltage can be measured in conjunction with the applied DC stack current. The DC stack current can be a known value that can be used together with the low frequency resistance or impedance (R_{LF}) of each cell (previously measured using the EIS measurement generated by the EIS extraction component 324) to estimate the open circuit voltage (E_{cell}) of each cell. In some examples, the open circuit voltage of a given cell is computed in accordance with:

$$Ecell = Erev + \frac{RT}{2 F} \{ ln ( \frac{{P}_{H 2} {P}_{O 2}^{1 / 2}}{{P}_{H 2 O}} ) \}$$

where E_{cell} represents the measured DC voltage of a particular cell, Eᵣₑᵥ represents a reversible cell voltage (e.g., a baseline cell voltage when low current is going through the cell and can be expressed as Erev=1.229−0.0009(T−298), T—temperature (K)), R is the ideal gas constant, F is the faraday constant, and P represents the partial pressures of the cell. From this expression, the stack level temperature and pressure can be measured (e.g., using the measured cell level DV voltage) and determined on a cell-by-cell basis. Variations in temperature and pressure across each cell of the electrolyzer can then be determined. These variations can be further used to improve the impedance estimation of difference cells.

In some cases, the control circuit 700 can implement a cyclic voltammetry mode. In this mode, the electrolyzer stack can be operating in an idle mode where a standing dc current is applied that is below the point of splitting water. In this mode, the current excitation circuitry is used to generate and apply a triangle voltage waveform (or any other suitable waveform) across the stack of cells. A voltage ramp rate can be programmable and can be approximately 50 mV/sec. As the voltage is swept cyclically between approximately 0 and 1V, a voltammogram can be produced to represent the applied current measured in volts against the potential. Features produced in various regions of the voltammogram can be used in conjunction with other system measurements, including the EIS measurements, to estimate the state of health of the electrolyzer stack.

In some cases, the control circuitry 700 can implement a self-discharge mode to measure the self-discharge of the electrolyzer. Specifically, this mode can be invoked when the electrolyzer stack is operating in an idle mode, which is at a standing DC current below the point of splitting water. In this mode a current excitation circuitry is used to bypass a step of current around the electrolyzer, which lowers the current through the electrolyzer to near zero. This causes the electrolyzer stack to begin self-discharging. While the electrolyzer is discharging, the voltage across some or all of the cells is measured and plotted against time. The change in voltage across the cells can be compared to determine, estimate or predict cell health. For example, if one cell changes voltage by an amount that is more than a threshold difference from an average change across the cells, that cell can be estimated to be in poor working condition. In some examples, features of a cell voltage waveform during the depolarization and relaxation periods (e.g., after a threshold period of time after the self-discharge mode is enabled) can be used in conjunction with other system measurements to further infer the state of health of the electrolyzer stack.

Referring back to FIG. 3, the impedance measurements over time and for different frequencies can be analyzed and processed by the machine learning system 330. The machine learning system 330 can be locally implemented, such as by control circuitry 310, and/or can be remotely implemented on a server accessible over the Interne. The machine learning system 330 can include multiple types of machine learning models (e.g., different types of neural networks). Each of the different types of machine learning models can be used to track and/or predict measurements of different components of the system.

As an example, the machine learning (ML) system 330 tracks the EIS output over time and makes predictions about performance, state-of-health and imminent failures of any of the cells of the electrolyzer system 100. The machine learning system 330 (using the same or a different machine learning model) may optionally take other measured parameters such as H₂/O₂/H₂O flow rates, cell DC voltage measurements, cell temperatures, temperature and/or pressure measurements collected or determined for each cell or stack of cells, measurements collected or estimated during the cyclic voltammetry mode, measurements collected or estimated during the self-discharge mode, overall stack voltage and/or current as measured at the power supply, etc., to fuse with the EIS measurements. As one example, the impedance of a cell as well as its rate of degradation can be a function of the cell temperature. As another example, the flow-rate of H₂ can be lowered when pinholes form in the cell. In this case the ML system 330 can be a sensor fusion system that incorporates EIS measurements with the other real-time parameters measured by the EIS measurement system 320.

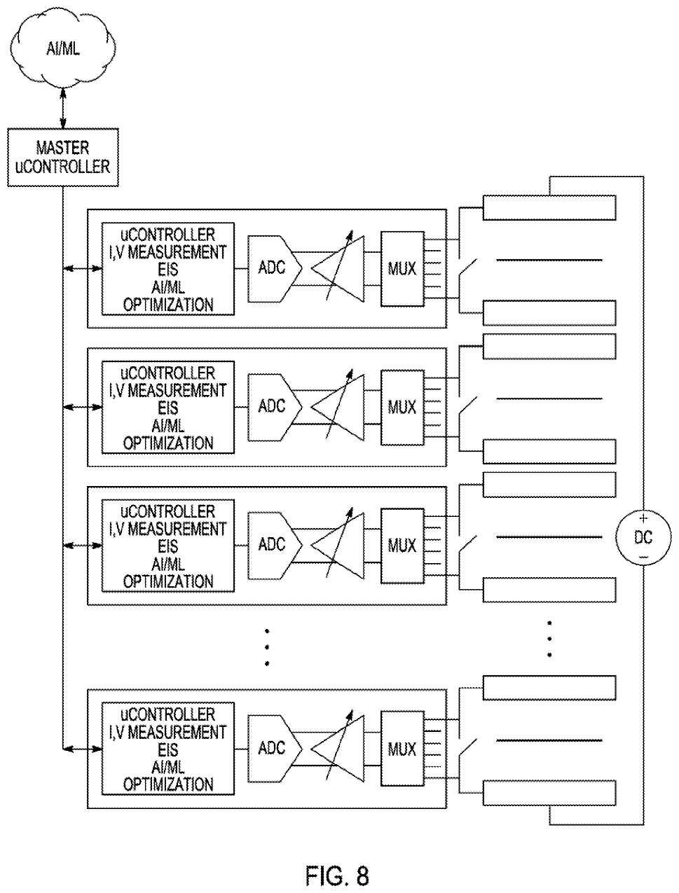

The outputs of the machine learning (ML) system 330 can be sent to the operator to make decisions about performing preventative maintenance. In addition, the outputs of the machine learning (ML) system 330 could be utilized as optional inputs to the control (monitoring) circuitry of the electrolyzer to enable optimal operation of the electrolyzer system 100, such as shutting down specific cells, bypassing specific cells (as shown in FIG. 8), or reducing the flow rate to enable better efficiency.

For example, as shown in FIG. 8, when the machine learning system 330 detects that a cell has degraded beyond a usable threshold, a bypass switch is engaged for that cell, so that the cell is taken out of the stack 114. In this case, the machine learning system 330 is outputting a decision on whether each cell has degraded or not. The bypass switch does not need to be an ON/OFF switch. The “switch” can be a variable resistor, in which case the current through the cell can be reduced when partial degradation of the cell is detected. In this case, the machine learning system 330 can output a “soft” decision on the degradation of each cell, and based on that soft decision, the amount of resistance applied to each cell can be controlled, such as to reduce the output from each cell, thereby lengthening the stack life.

For example, a machine learning model (or machine learning technique) can be trained based on training data to predict performance and/or failure of a given cell. As an example, the machine learning model can be a neural network of a particular type. The neural network is trained to establish a relationship between a plurality of operating parameters (e.g., voltage across one or more of the plurality of electrolytic cells, impedance measurements and/or changes in impedance over time per frequency, EIS, current, temperature, pressure measurements collected or determined for each cell or stack of cells, measurements collected or estimated during the cyclic voltammetry mode, measurements collected or estimated during the self-discharge mode (e.g., depolarization and/or relaxation period voltage measurements), and/or gas or fluid flow associated with the one or more of the plurality of electrolytic cells) and performance or failure. For example, one training data set can indicate that for a given set of parameters, the cell failed to operate within a threshold period of time. Another training data set can indicate that for a given set of parameters, another cell outputted hydrogen and oxygen at a particularly low level and could have outputted the hydrogen and oxygen faster without failing. Another training data set can include training impedance profiles.

The neural network can be trained to establish a set of parameters of the neural network based on such data to minimize a loss function. For example, the neural network can predict failure or performance metrics given a set of parameters in a set of the training data (e.g., the training impedance profiles). The predicted failure or performance metrics can be compared with the actual ground truth failure or performance metrics of the set of training data (e.g., impedance profiles representing normal conditions and impedance profiles representing abnormal conditions). A loss can be computed based on a deviation between the predicted failure or performance metrics and the ground truth failure or performance metrics. Parameters of the neural network can then be updated based on the computed loss. Subsequent or additional training data sets can similarly be processed to update parameters of the neural network until a stopping criterion is satisfied or until all of the training data is processed.

In this way, when the neural network is presented with a new set of parameters of a given cell in the stack 114, the neural network can predict failure or performance metrics of the given cell.

A variety of different machine learning algorithms could be utilized for this application. For example, feature extractors can be applied to time-synchronized EIS measurements of multiple cells along with other available inputs, such as flow rates, to produce a minimal set of features that contain sufficient information about the electrolyzer cells to determine whether the operation is normal. Classifiers or anomaly detectors can be used to operate on the features of the feature extractors and detect if the operation is within normal limits or not. Each of the different machine learning algorithms can be implemented on the same component or across different components of the system.

In some embodiments, the feature extractors can be trained to generate impedance profiles as a function of frequency. Namely, the feature extractors generate feature representations for classification by converting impedance as a function of frequency to one or more features. These impedance profiles can be analyzed to identify and generate impedance profiles of normal and/or abnormal operation conditions of electrolyzer system 100. In one example, the feature extractor can collect the impedance measurements over time for a range of frequencies along with other real-time parameters. The feature extractor can generate a training impedance profile (feature representation) and compare features of the impedance profile to the predetermined abnormal and/or normal impedance profiles. The feature extractor can compute a cost function representing a deviation between a given observed impedance profile and a training impedance profile to determine that more than a threshold quantity of features of the generated impedance profile match features of the predetermined abnormal impedance profile. In response, the feature extractor can output an indication to an operator or the control circuitry that the electrolyzer system 100 is operating abnormally. The feature extractor can generate the features or impedance profile using an auto-encoder or other neural network structure.

In some embodiments, feature extractors can be trained by selecting the features (circuit parameters) that generate an EIS spectrum that is closest to the measured spectrum in L2 norm (Least-Squares Fitting), or L2 norm penalized or regularized in various ways (e.g., where the weight applied to the loss of the imaginary impedance component is a factor larger than the weight applied to the loss of the real component; or where different frequencies are weighted differently); or cross entropy loss. The determination of parameters that minimize the chosen loss can be done via, e.g., gradient descent using backpropagation, or via Markov Chain Monte-Carlo, or directly.

In some embodiments, the classifiers can include simple threshold limits on the features that indicate whether a feature is within normal limits or anomalous. The detectors or classifier can be implemented as random forests that are designed to detect anomalous data points. In such cases, the detector receives the features or impedance profile from the feature extractor and determines whether the features are indicative of normal or abnormal operation. The classifier can be implemented as a neural network trained on examples of cells that operate normally and/or cells that have defects.

In some embodiments, the extractor and the classifiers are trained end-to-end as one system, such as based on a same set or batch of training data.

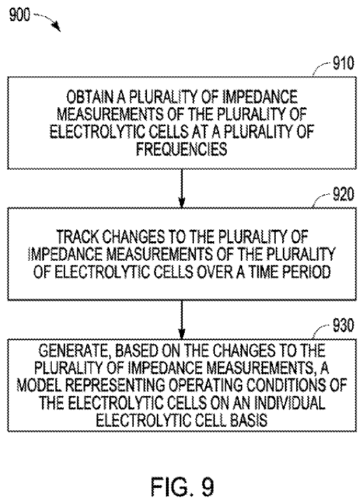

FIG. 9 is a flow diagram depicting example process 900 for operating or configuring an electrolyzer, in accordance with various embodiments. The operations of the process 900 may be performed in parallel or in a different sequence, or may be entirely omitted. In some embodiments, some or all of the operations of the process 900 may be embodied on a computer-readable medium and executed by one or more processors.

At operation 910. control circuitry of an electrolyzer obtains a plurality of impedance measurements of the plurality of electrolytic cells at a plurality of frequencies.

At operation 920, the control circuitry tracks changes to the plurality of impedance measurements of the plurality of electrolytic cells over a time period.

At operation 930, the control circuitry generates, based on the changes to the plurality of impedance measurements, a model representing operating-conditions of the electrolytic cells on an individual electrolytic cell basis.

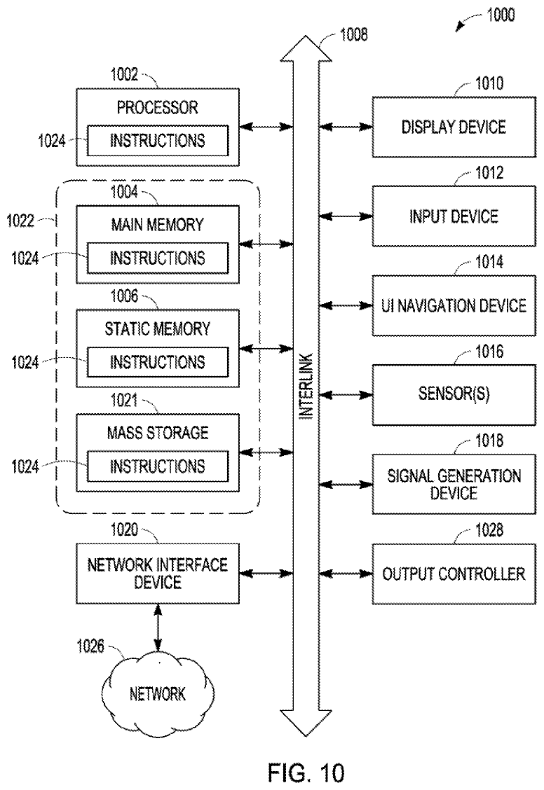

FIG. 10 is a block diagram of an example machine 1000 upon which any one or more of the techniques (e.g., methodologies) discussed herein may be performed. In alternative embodiments, the machine 1000 may operate as a standalone device or may be connected (e.g., networked) to other machines. In a networked deployment, the machine 1000 may operate in the capacity of a server machine, a client machine, or both in server-client network environments. In an example, the machine 1000 may act as a peer machine in a peer-to-peer (P2P) (or other distributed) network environment. The machine 1000 may be a personal computer (PC), a tablet PC, a set-top box (STB), a personal digital assistant (PDA), a mobile telephone, a web appliance, an IoT device, an automotive system, an aerospace system, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as via cloud computing, software as a service (SaaS), or other computer cluster configurations.

Examples, as described herein, may include, or may operate by, logic, components, devices, packages, or mechanisms. Circuitry is a collection (e.g., set) of circuits implemented in tangible entities that include hardware (e.g., simple circuits, gates, logic, etc.). Circuitry membership may be flexible over time and underlying hardware variability. Circuitries include members that may, alone or in combination, perform specific tasks when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer-readable medium physically modified (e.g., magnetically, electrically, by moveable placement of invariant-massed particles, etc.) to encode instructions of the specific operation. In connecting the physical components, the underlying electrical properties of a hardware constituent are changed, for example, from an insulator to a conductor or vice versa. The instructions enable participating hardware (e.g., the execution units or a loading mechanism) to create members of the circuitry in hardware via the variable connections to carry out portions of the specific tasks when in operation. Accordingly, the computer-readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry, at a different time.

The machine (e.g., computer system) 1000 may include a hardware processor 1002 (e.g., a central processing unit (CPU), a graphics processing unit (GPU), a hardware processor core, or any combination thereof, such as a memory controller, etc.), a main memory 1004, and a static memory 1006, some or all of which may communicate with each other via an interlink (e.g., bus) 1008. The machine 1000 may further include a display device 1010, an alphanumeric input device 1012 (e.g., a keyboard), and a user interface (UI) navigation device 1014 (e.g., a mouse). In an example, the display device 1010, alphanumeric input device 1012, and UI navigation device 1014 may be a touchscreen display. The machine 1000 may additionally include a storage device 1022 (e.g., drive unit); a signal generation device 1018 (e.g., a speaker); a network interface device 1020; one or more sensors 1016, such as a Global Positioning System (GPS) sensor, wing sensors, mechanical device sensors, temperature sensors, ICP sensors, bridge sensors, audio sensors, industrial sensors, a compass, an accelerometer, or other sensors. The machine 1000 may include an output controller 1028, such as a serial (e.g., universal serial bus (USB)), parallel, or other wired or wireless (e.g., infrared (IR), near field communication (NFC), etc.) connection to communicate with or control one or more peripheral devices (e.g., a printer, card reader, etc.).

The storage device 1022 may include a machine-readable medium on which is stored one or more sets of data structures or instructions 1024 (e.g., software) embodying or utilized by any one or more of the techniques or functions described herein. The instructions 1024 may also reside, completely or at least partially, within the main memory 1004, within the static memory 1006, or within the hardware processor 1002 during execution thereof by the machine 1000. In an example, one or any combination of the hardware processor 1002, the main memory 1004, the static memory 1006, or the storage device 1022 may constitute the machine-readable medium.

While the machine-readable medium is illustrated as a single medium, the term “machine-readable medium” may include a single medium or multiple media (e.g., a centralized or distributed database, or associated caches and servers) configured to store the one or more instructions 1024.

The term “machine-readable medium” may include any transitory or non-transitory medium that is capable of storing, encoding, or carrying transitory or non-transitory instructions for execution by the machine 1000 and that cause the machine 1000 to perform any one or more of the techniques of the present disclosure, or that is capable of storing, encoding, or carrying data structures used by or associated with such instructions. Non-limiting machine-readable medium examples may include solid-state memories, and optical and magnetic media. In an example, a massed machine-readable medium comprises a machine-readable medium with a plurality of particles having invariant (e.g., rest) mass. Accordingly, massed machine-readable media are not transitory propagating signals. Specific examples of massed machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 1024 (e.g., software, programs, an operating system (OS), etc.) or other data that are stored on the storage device 1022 can be accessed by the main memory 1004 for use by the hardware processor 1002. The main memory 1004 (e.g., DRAM) is typically fast, but volatile, and thus a different type of storage from the storage device 1022 (e.g., an SSD), which is suitable for long-term storage, including while in an “off” condition. The instructions 1024 or data in use by a user or the machine 1000 are typically loaded in the main memory 1004 for use by the hardware processor 1002. When the main memory 1004 is full, virtual space from the storage device 1022 can be allocated to supplement the main memory 1004; however, because the storage device 1022 is typically slower than the main memory 1004, and write speeds are typically at least twice as slow as read speeds, use of virtual memory can greatly reduce user experience due to storage device latency (in contrast to the main memory 1004, e.g., DRAM). Further, use of the storage device 1022 for virtual memory can greatly reduce the usable lifespan of the storage device 1022.

The instructions 1024 may further be transmitted or received over a communications network 1026 using a transmission medium via the network interface device 1020 utilizing any one of a number of transfer protocols (e.g., frame relay, interact protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone Service (POTS) networks, and wireless data networks (e.g., Institute of Electrical and Electronics Engineers (IEEE) 802.11 family of standards known as Wi-Fi®, IEEE 802.16 family of standards known as WiMax®, IEEE 802.15.4 family of standards, P2P networks), among others. In an example, the network interface device 1020 may include one or more physical jacks (e.g., Ethernet, coaxial, or phone jacks) one or more antennas to connect to the communications network 1026. In an example, the network interface device 1020 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any tangible or intangible medium that is capable of storing, encoding, or carrying instructions for execution by the machine 1000, and includes digital or analog communications signals or other tangible or intangible media to facilitate communication of such software.

Each of the non-limiting claims or examples described herein may stand on its own, or may be combined in various permutations or combinations with one or more of the other examples.

The above detailed description includes references to the accompanying drawings, which form a part of the detailed description. The drawings show, by way of illustration, specific embodiments in which the inventive subject matter may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more claims thereof), either with respect to a particular example (or one or more claims thereof), or with respect to other examples (or one or more claims thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended; that is, a system, device, article, composition, formulation, or process that includes elements in addition to those listed after such a term in a claim are still deemed to fall within the scope of that claim. Moreover, in the following claims, the terms “first,” “second,” “third,” etc. are used merely as labels, and are not intended to impose numerical requirements on their objects.

Method examples described herein may be machine- or computer-implemented at least in part. Some examples may include a computer-readable medium or machine-readable medium encoded with transitory or non-transitory instructions operable to configure an electronic device to perform methods as described in the above examples. An implementation of such methods may include code, such as microcode, assembly-language code, a higher-level-language code, or the like. Such code may include transitory or non-transitory computer-readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact discs and digital video discs), magnetic cassettes, memory cards or sticks, random access memories (RAMs), read-only memories (ROMs), and the like.

The above description is intended to be illustrative, and not restrictive. For example, the above-described examples (or one or more claims thereof) may be used in combination with each other. Other embodiments may be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above detailed description, various features may be grouped together to streamline the disclosure. This should not be interpreted as intending that a disclosed feature not listed in the list of claims is essential to any claim. Rather, inventive subject matter may lie in less than all features of a particular disclosed embodiment. Thus, the following claims are hereby incorporated into the detailed description as examples or embodiments, with each claim standing on its own as a separate embodiment, and it is contemplated that such embodiments may be combined with each other in various combinations or permutations. The scope of the inventive subject matter should be determined with reference to the appended claims, along with the full scope of equivalents to which such claims are entitled.

1. A system comprising:
monitoring circuitry coupled to a plurality of electrolytic cells, the monitoring circuitry configured to perform operations comprising:
obtaining a plurality of impedance measurements of the plurality of electrolytic cells at a plurality of frequencies;
tracking changes to the plurality of impedance measurements of the plurality of electrolytic cells over a time period; and
generating, based on the changes to the plurality of impedance measurements, a model representing operating conditions of the electrolytic cells on an individual electrolytic cell basis.

2. The system of claim 1, wherein the system includes an electrolyzer comprising the plurality of electrolytic cells, each of the electrolytic cells comprising an electrolyte, two electrodes and a pair of bipolar plates, wherein the model is configured to estimate at least one of state-of-health or performance of a given electrolytic cell, predict whether the given electrolytic cell is operating and degrading normally or abnormally, or identify an abnormality of the electrolytic cell.

3. The system of claim 1, wherein the model comprises a machine learning technique that is trained based on training data to predict health of an electrolytic cell, the training data comprising a plurality of training samples of Electrochemical Impedance Spectroscopy (EIS) data and associated performance or failure information.

4. The system of claim 1, wherein the monitoring circuitry comprises an Electrochemical Impedance Spectroscopy (EIS) measurement system, the EIS generating an impedance as a function of frequency of each of the plurality of electrolytic cells.

5. The system of claim 4, wherein the EIS generates the impedance over a range of frequencies from 0.1 mHz to 10 kHz, a subset of frequencies within the range of frequencies, or one or more specific frequencies within the range of frequencies.

6. The system of claim 1, wherein the operations further comprise:
converting the plurality of impedance measurements into a plurality of components of an equivalent circuit model representing each electrolytic cell by solving a set of equations that relate a total impedance of the cell to the impedance of each of the components at a number of frequencies;
tracking values of the components over time to determine whether any of the components are changing over time; and
identifying one or more of the operating conditions that correspond to the components that are changing over time.

7. The system of claim 6, wherein the plurality of components comprise a first component representing resistance of electron-conducting metallic cell components at a cathode and an anode, respectively; a second component representing ionic resistance of a solid polymer electrolyte (SPE); a third component representing cathodic polarization resistance; a fourth component representing anodic polarization resistance; a fifth component representing a cathodic constant phase element; a sixth component representing an anodic constant phase element for a pseudo-capacitive anode/electrolyte interface; a seventh component representing cathodic diffusion impedance; and an eighth component representing anodic diffusion impedance.

8. The system of claim 1, wherein the operations further comprise:
applying a stimulus input in parallel with a power supply input of an electrolyzer;
measuring cell voltages of each of the plurality of electrolytic cells as a result of applying the stimulus input;
synchronously demodulating the measured cell voltages of the plurality of electrolytic cells based on the applied stimulus input; and
computing impedance of the plurality of electrolytic cells based on the demodulated measured cell voltage of the plurality of electrolytic cells.

9. The system of claim 8, wherein the stimulus input comprises a sinusoid signal cycled through the plurality of frequencies or a sum of several sinusoid signals.

10. The system of claim 8, wherein the stimulus input comprises a wideband signal or a pulsed-waveform signal.

11. The system of claim 8, wherein the operations further comprise filtering demodulated measured cell voltage of the plurality of electrolytic cells.

12. The system of claim 8, wherein synchronously demodulating comprises performing IQ demodulation by:
shifting the stimulus input by 90 degrees;
multiplying the measured cell voltage of each cell by the stimulus input to generate an in-phase (I) component of the demodulated cell voltage; and
simultaneously measuring the measured cell voltage of each cell by the shifted stimulus input to generate a quadrature (Q) component of the demodulated cell voltage.

13. The system of claim 1, wherein the operations further comprise:
measuring a plurality of voltages of the plurality of electrolytic cells over the time period;
measuring a total voltage of a stack of the plurality of electrolytic cells over the time period; and
estimating the plurality of impedance measurements based on the measured plurality of voltages of the plurality of electrolytic cells and the measured total voltage of the stack, such that, in the time period, multiple measurements of each cell voltage and the total voltage are performed and impedance is estimated based on an assumption that the impedance does not vary during the time period.

14. The system of claim 13, wherein the plurality of impedance measurements are estimated to maximize a likelihood function of the measured plurality of voltages and the total voltage of the stack over the time period, the likelihood function comprising a probability of observed voltages as a function of the impedance.

15. The system of claim 1, wherein the operations further comprise:
generating, by a feature extractor, a feature representation that contains information for classification based on the impedance as a function of frequency; and
determining, by a classifier, whether a plurality of features represent abnormal operation of an electrolyzer.

16. The system of claim 15, wherein the classifier is trained by:
obtaining a plurality of training data comprising a plurality of training impedance profiles;
computing a cost function based on a deviation between the plurality of training impedance profiles and predetermined impedance profiles representing normal operating conditions; and
updating parameters of the classifier based on the cost function.

17. The system of claim 15, wherein the feature extractor is configured to compare the feature representation to predetermined feature representations representing normal operating conditions to determine abnormal operation of the electrolyzer.

18. The system of claim 1, wherein the operations further comprise:
determining a first type of fault of an electrolyzer in response to detecting a first impedance value within a first impedance range at a first frequency; and
determining a second type of fault of the electrolyzer in response to detecting a second impedance value within a second impedance range at a second frequency.

19. A method comprising:
obtaining, by monitoring circuitry coupled to a plurality of electrolytic cells of an electrolyzer, a plurality of impedance measurements of the plurality of electrolytic cells at a plurality of frequencies, each of the electrolytic cells comprising an electrolyte, two electrodes and a pair of bipolar plates;
tracking changes to the plurality of impedance measurements of the plurality of electrolytic cells over a time period; and
generating, based on the changes to the plurality of impedance measurements, a model representing operating conditions of the electrolytic cells on an individual electrolytic cell basis.

20-25. (canceled)

26. A non-transitory computer-readable medium comprising instructions that, when executed by one or more processors, configure the one or more processors to perform operations comprising:
obtaining, by monitoring circuitry coupled to a plurality of electrolytic cells of an electrolyzer, a plurality of impedance measurements of the plurality of electrolytic cells at a plurality of frequencies, each of the electrolytic cells comprising an electrolyte, two electrodes and a pair of bipolar plates;
tracking changes to the plurality of impedance measurements of the plurality of electrolytic cells over a time period; and
generating, based on the changes to the plurality of impedance measurements, a model representing operating conditions of the electrolytic cells on an individual electrolytic cell basis.

27-31. (canceled)
